(19) United States
(12) Patent Application Publication
(10) Pub. No.: US 2024/0414289 A1
(43) Pub. Date: Dec. 12, 2024

(54) ATTENUATION OF OPTICAL ARTIFACT IN OVERLAP REGIONS OF A MULTI-TILE PROJECTION SYSTEM

(71) Applicant: Electric Picture Display Systems, Inc., Melbourne, FL (US)

(72) Inventors: Daniel Green, Melbourne, FL (US); Thomas Miller, Titusville, FL (US); Joey Bruton

(21) Appl. No.: 18/636,678

(22) Filed: Apr. 16, 2024

Related U.S. Application Data
(60) Provisional application No. 63/496,691, filed on Apr. 17, 2023.

(51) Int. Cl. H04N 9/31

(52) U.S. Cl. CPC H04N 9/3179; H04N 9/3147

(57) ABSTRACT

A variable masking scheme for attenuating undesired optical artifact (26, 28, 30, 32) appearing in overlap regions (20, 22) between adjacent projection tiles (12, 14, 16) of a multi-projector (1, 2, 3) projection system (10). Different portions (54, 60) of a projection beam (43) are blocked by a mask apparatus (34) in response to a value (66) of a variable associated with a projected scene in order to attenuate respective artifacts correlated with that variable. The variable may be an optical parameter such as brightness (e.g., for a nighttime scene versus a dawn scene) or color, and the artifacts may be bright spots or shadows. The variable masking scheme may involve moving a single mask (36) to multiple positions or using multiple alternative masks (50, 56) in response to the variable.

### PRIORITY

This application claims the benefit of provisional application No. 63/496,691 filed on Apr. 17, 2023.

### BACKGROUND OF THE INVENTION

There is a growing demand to create large panoramas with digital projection technologies in many economic and industrial sectors. These include entertainment, video-gaming, simulation training, military operations, advertising and business applications, all of which require or benefit from projection of large, high-quality images. With demand for display of large, high-resolution continuous images, system designs must address numerous complex projection problems. For example, image displays on large cylindrical and dome-shaped screens often require projection of a series of overlapping images. Each projected image is generated from a separate projector in a multi-channel display system to build extended horizontal or vertical fields of view. However, sustaining high image quality in the transitions between adjoining image tiles can be difficult in view of optical effects and brightness issues resulting from pixel overlap.

To enhance realism the transitions between individual tiles of image data must be rendered unnoticeable, i.e., seamless to the viewer. Achieving such a transition between adjoining image tiles depends in part on alignment of pixel data from different projectors on the screen. Additional treatments are commonly applied to regions where beams from different projectors contain overlapping image data. Otherwise, abrupt changes in brightness would result from projection of duplicate pixel data onto the same region of a screen. The term “soft edge matching” was coined in the 1990's and involved overlapping these images to transition between overlapping projections of adjoining image tiles.

A variety of treatments have been applied to mitigate such noticeable changes in screen brightness and other related artifacts, but these have performance limitations or other disadvantages. With multiple projectors beaming the same pixel information toward a region of overlap, treatments for image blending include software-driven electronic adjustments and hardware-based techniques. Under suitable levels of screen brightness, software-driven electronic adjustments, referred to as “software blending”, have proven to be effective without permitting any overlap of the pixel information in adjoining tiles. As systems incorporate larger or more complex projection geometries, it becomes more difficult to render non-overlapping image projections from discrete tiles while retaining a high quality, seamless appearance, e.g., without creating disruptions along the interfaces of tiles being seamed into one continuous image. The difficulty of eliminating the noticeable artifact can become more challenging under very low light conditions in those systems which do not provide a true black light level (i.e., zero light output) as the lowest level of screen brightness. For example, at the darkest level (i.e., a digital zero), systems using digital light processors always project some light. In regions of tile overlap, when a brightness level is supposed to be at or near digital zero, the brightness level which results after adjustment with software blending can remain noticeably too high, in part due to the additive effect in overlapping image pixels.

Summarily, software blending adjusts the contribution to screen brightness levels across blend zones to null otherwise additive effects of duplicate image information on brightness levels. In a well-known implementation of software blending across a region of overlap between a pair of adjacent image tiles, the screen brightness level along the first of the adjacent tiles may spatially vary along one direction from a maximum value to a minimum value. At the same time and across the same region of overlap, the screen brightness level along the second in the pair of overlapping tiles may spatially vary along the same direction from a minimum value to a maximum value.

Software blending can generate acceptable brightness levels to provide a seamless transition across a region of image tile overlap provided there is sufficient dynamic range to reduce net levels to be substantially equivalent to levels produced by one projector beam. That is, at relatively high brightness levels, software blending methods can sufficiently reduce screen brightness of individual pixels in regions of tile overlap to levels produced by one projector beam. However, software blending is less effective at relatively low light levels (e.g., night-time scenes). Another contributing factor may be light scattering derived from reflective surfaces or lenses within the projector, as low level residual light is still emitted from the projector's objective lens even when no active pixels are projected on-screen. Thus, without regard to the actual contributing factors, brightness artifact levels in regions of tile overlap can remain visibly evident and distracting to the viewer. Under these conditions, software blending methods cannot create the desired seamless transition between image tiles.

In lieu of software blending, two distinct types of hardware-based optical device designs and methods have been used to adjust regions of image tile overlap in tiled arrays: optical blending and optical blocking. These may be used in place of or in addition to software blending methods. Both optical blending and optical blocking are useful alternatives under low light conditions.

The primary function of an optical blend plate is to blend or mix and to smooth or blur abrupt changes in brightness levels across regions of tile overlap. Blend plates do not primarily block light along each side of an image tile transition line. Rather, they can retain overlapping pixel data while reducing overall light levels in tile transition zones to reduce noticeability of transitions between adjoining edge tiles. Generally, optical blend plate designs form a class of devices that obscure transitions between image tiles by blurring or scattering some of the light present in the projection beams. For each pair of overlapping projection beams, a pair of blend plates creates a blend zone on the projection screen. This is accomplished by insertion of edge profiles 38 of respective blend plates in front of portions of the two overlapping projection beams. Through blurring or scattering, blend plate edge portions remove or redistribute light before the beams impinge on blend regions on the screen. The light which ultimately impinges on the projection screen may have a reduced spatial brightness gradient across the transition zone to render each tile transition less noticeable. More generally, blend plates may blur the image in the transition zone, i.e., degrade the sharpness of overlapping light that is otherwise well-focused. On the other hand, the scattering process can introduce significant noise with possible loss of pixel resolution. These effects must be limited to avoid obscuring image details in low light level scenes and to avoid noticeable degradation in image quality.

In contrast to optical blending, blocking masks reduce or completely remove pixel data in tile overlap regions. In principle this minimizes or eliminates projection and superposition of duplicate pixel data. For a transition between two overlapping projection beams, each in a pair of blocking mask plates has an edge profile 38 designed to prevent select portions of the duplicate pixel data in each of the two beams from impinging on the projection screen. Each blocking mask edge profile 38 provides a contour which blocks light along a common line, e.g., in a narrow zone of transition between image tiles. On each side of the line or zone, the screen receives pixel data from only one projection beam. By defining a transition line or zone in the region of overlap, each blocking mask removes pixel data from a different one of the beams on each side of the line or zone to eliminate projection of duplicate data onto the screen.

To suitably define a line or zone of transition within the region of tile overlap, the designs of blocking mask edge profiles 38 may be specific to the elevation or horizontal position of pairs of adjoining tiles, e.g., design of, for example, the projection beam angles of tiles relative to the screen and the screen shape. In some cases the design may closely approximate screen contours to remove brightness effects when, for example, the keystone effect is present on a cylindrically shaped screen (e.g., due to the fact that the projector may not have a lens shift and physically must be angled down/out of sight of the viewer, either overhead or underneath). Effective design of blocking mask plates becomes more challenging as projection systems incorporate more complex, e.g., curved, screen geometries and optical corrections to accommodate these geometries.

With greater demands for higher levels of picture quality under conditions of low brightness levels, the known optical device designs and methods for creating seamless tile transitions either have intrinsic performance limitations or require greater cost due to increased system complexities. Deficiencies in contours of blocking mask patterns may not be apparent until system installation, e.g., when bright zones or other artifact become apparent. These may be due to minor variations from specified values for projector and/or screen placement and/or geometries, e.g., due to field installation limitations.

To accommodate such as-built system dimensional variations and to eliminate unanticipated bright zone artifact in screen tile overlap regions during very low light (e.g. night-time) scene projections, mask plates may have on-site adjustable edge profiles, as described in United States Patent Number U.S. Pat. No. 9,888,219 B1 (referred to herein as the '219 Patent) and incorporated herein by reference. Such mask plates can be fine-tuned as part of the projection system installation process to obtain the best achievable dark screen image quality for the particular installation. To this end, brightness artifact has been minimized in tile overlap regions. Yet it is believed there is continued value in developing systems and processes to further reduce such artifact in multi-projector, continuous scene projection systems.

### BRIEF DESCRIPTION OF THE DRAWINGS

The invention is explained in the following description in view of the drawings for which:

FIG. 1A is a schematic illustration of a plan view of a portion of a projection system to which embodiments of the invention apply;

FIG. 1B is a plan view schematically illustrating a multi-tile scene displayed by the projection system of FIG. 1A;

FIGS. 2A-2D are elevation views of a projection screen schematically illustrating types of optical artifacts that can occur when projecting scenes under differing brightness conditions;

FIG. 3 is a schematic illustration of a masking apparatus including an elevation view of a single mask according to one embodiment of the invention;

FIGS. 4A-4C illustrate an embodiment of the invention utilizing a single mask;

FIG. 5 is a block diagram of a control system 62 that may be used in an embodiment of the invention.

FIG. 6 is a partial elevation view of a projection system utilizing multiple mask positioning mechanisms; and

FIGS. 7A-7C illustrate an embodiment of the invention utilizing a plurality of masks.

Like features are annotated with like reference numbers throughout the different drawings Features shown in the figures may not be drawn to scale.

### SUMMARY OF THE INVENTION

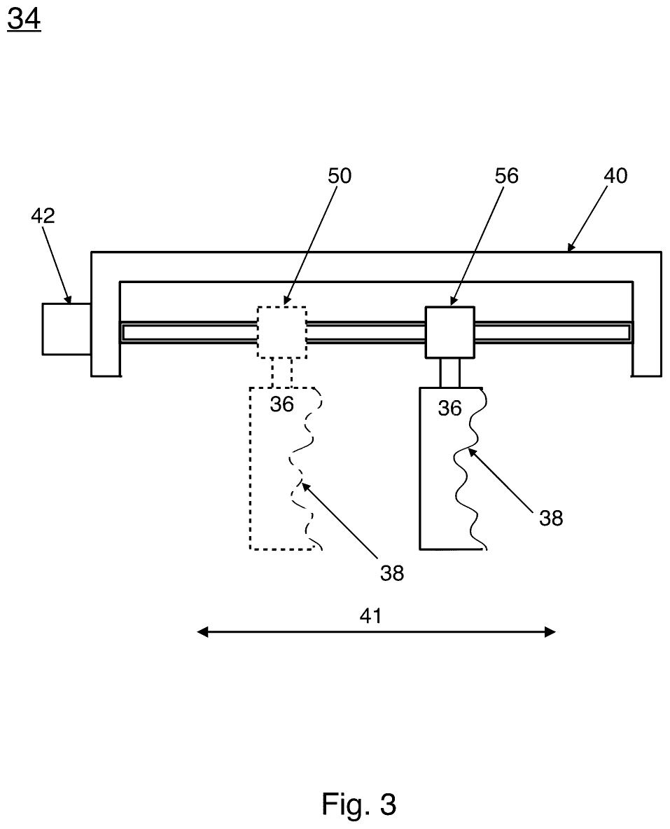

The invention concerns use of masks to remove artifact, including brightness effects and shadowing present along tile overlap regions in a video projection. Embodiments and applications of the invention involve use of blocking masks such as disclosed in the '219 Patent, including the type having adjustable edge profiles operable in tile overlap regions created by adjoining projectors. See FIG. 3 therein. One or multiple adjustable blocking masks can be inserted and adjusted to effectively remove artifact otherwise present in the transitions between adjoining image tiles. Embodiments of such masks disclosed in the '219 Patent are exemplary.

In one series of embodiments there is disclosed a method of projecting a scene using a plurality of projectors each projecting a beam to form a respective tile of the scene on a reflective surface. Adjacent tiles partially overlap in respective overlap regions, together forming a continuous projected scene across the reflective surface. The method includes masking a first portion of a first beam to attenuate a first optical artifact appearing in a first overlap region along the reflective surface while projecting a first scene. A second portion of the first beam different from the first portion is masked to attenuate a second optical artifact appearing in the first overlap region of the reflective surface while projecting a second scene different from the first scene. Also disclosed is an image projection system operable to practice the afore described method, the image projection system including subsystem configured to move a mask to a first position to mask the first portion of the first beam and to move the mask to a second position to mask the second portion of the first beam. The subsystem of the image projection system may comprise a stepper motor.

According to another series of embodiments, an image projection system has at least a pair of projectors, a masking apparatus and a controller. The pair of projectors operate to project a respective pair of partially overlapping image tiles onto a surface to create a continuous image of a scene across the surface. The masking apparatus includes at least one mask positionable to partially block a portion of at least one of the image tiles in order to attenuate an optical artifact in the continuous image in a region where the image tiles overlap. The controller is operable to command the masking apparatus to block a first portion of the at least one of the image tiles when the system projects a first scene, and to command the masking apparatus to block a second portion of the at least one of the image tiles, different from the first portion, when the system projects a second scene, where the first and second scenes differ in an optical parameter that results in different respective first and second artifacts in the region where the image tiles overlap.

In still another series of embodiments in a multi-projector continuous scene projection system, an overlap of adjacent projection tiles may give rise to undesired optical artifacts in a projected continuous scene image and, according to an improvement therein, a masking apparatus is operable to block a portion of a projection beam forming at least one of the tiles. The apparatus provides for determining an optical parameter of a projected image and includes means for controlling the masking apparatus to block a first portion of the at least one of the tiles to attenuate a first artifact in response to a projected image having an optical parameter of a first value or, alternately, to block a second portion of the at least one of the tiles to attenuate a second artifact in response to a projected image having an optical parameter of a second value. In example embodiments of the improvement, the optical parameter comprises a brightness parameter or a color parameter. Also according to the improvement, the masking apparatus may comprise a stepper motor; and the means for controlling the masking apparatus to block a second portion of the at least one of the tiles may comprise a controller programmed to control the stepper motor to position a mask in a desired position responsive to a value of the optical parameter of a particular projected scene image. In other embodiments, the means for controlling the masking apparatus may comprise a controller programmed to position an alternate one of two masks to block the respective first or second portion responsive to a value of the optical parameter of a particular projected scene image. In another example embodiment each of the two masks comprises a unique and different edge profile.

### DETAILED DESCRIPTION OF THE INVENTION

The assignee of the present invention designs and installs large continuous scene projection systems for a variety of end-use customers. By way of examples, projection systems are often used for simulation training in military operations (land, sea or air) or commercial maritime operations. Simulation training for nighttime operations can be among the most demanding for delivering high quality immersive experiences because projection systems can create brightness artifacts in the overlap regions between projection tiles, as described above. The assignee's systems incorporate adjustable masks as described in the aforementioned '219 Patent and they have previously satisfied customer requirements for nighttime training scenarios.

However, the present inventors now address previously unanticipated brightness artifact issues that can occur during transitions between brighter and darker projections. That is, in addition to the well-known existence of bright areas caused by the overlap of pixel data present in adjacent projection tiles, when projecting a very dark scene, the present inventors have discovered a relatively simple method and apparatus to mitigate other undesirable optical artifacts referred to herein as secondary artifacts, which can appear when the system is optimized for a relatively darker (nighttime) scene. In one example, the same settings used for the relatively darker scene are then used during a subsequent time period while projecting a relatively brighter scene and before a transition to project an even brighter, e.g., full daylight, scene. An example of such an artifact is a darker-than-realistic (i.e., unnaturally shadowed) area that may appear when projecting an intermediate scene during a transition period between a relatively darker scene (for example, a very dark nighttime scene) and a relatively bright scene (occurring, for example, after the break of dawn, perhaps even a scene which is nearly as bright as full daylight). The transition period may occur during a dusk or dawn transition and, for example, may be a scene dimly lit by a distant light source, such as outdoor electrical lighting from a nearby or distant community located along a distant coastline in a maritime scene.

The present inventors have found that such artifacts may unexpectedly appear and disappear as a function of pixel brightness in the portion of a scene near or about the transition between adjacent projection tiles. As another example, when projecting a view from a ship deck, as the scene transitions from nighttime to daylight, there may be a period, e.g., perhaps lasting about 30-45 minutes, during which one or more regions of the projected scene, which are near or about the transition between adjacent projection tiles, will become unnaturally darker than an immediately adjacent region, e.g., in the form of a dark band, perhaps due to an optical artifact generated within the projection system and not due to any expected (e.g., simulated or naturally occurring) dusk-to-dawn brightness change in the scene imagery.

Based on the foregoing observations it is believed there are at least two different types of brightness artifacts, each occurring under different brightness conditions. For purposes of distinguishing between different types of brightness artifacts arising in, for example, systems using digital light processors (which always project some light), the term “primary artifact” is used to refer to the type of artifact associated with a lowest brightness level (i.e., at or near digital zero). That is, primary artifact refers to artifact which occurs in or about overlapping screen tile portions during very low light level night scenes, i.e., at or near digital zero. Primary artifact is understood to be directly attributable to additive effects of overlapping pixels and is a brightness artifact of the type removable according to teachings in the '219 Patent. The term secondary artifact refers to other types of artifact occurring at higher brightness levels beyond the minimum range of brightness at which a primary artifact is first observable, e.g., above digital zero. For example, secondary artifacts may occur in natural outdoor scenes at brightness levels higher than levels first occurring at the break of dawn or around sunset or dusk, e.g., shortly before the full darkness of night.

The shape of secondary artifact(s) may vary from one tile overlap region to another. In part, this may be due to projecting imagery on a curved screen. Regardless of the shape, secondary artifact may fade or completely disappear once the overall brightness level of the scene (e.g., about the transition between adjacent projection tiles) increases toward full daylight conditions. Generally, the term artifact as used herein is not necessarily limited to the exemplary unintended variations in brightness, and may also include any other visually perceptible variations.

To summarize, solutions according to the invention are not based with certainty on specific sources or causes of secondary artifacts. Possible explanations may include, without limitation, effects of scattering, reflection, refraction, diffusion, interference or leakage of light, e.g., incident on an optical blocking mask or another component in the projection system, or may result from an unmatched non-linearity in the control of pixel brightness in the software used to control bright spots in the overlap regions of the projected scene. Regardless of the source, such artifacts are undesirable because they often appear unnatural or can be distracting to the viewer. They do not appear to accurately represent the true scene and may obscure useful visual information. Accordingly, this invention was developed to mitigate or, preferably, to completely eliminate, such artifacts based on relatively inexpensive modifications to projection hardware or changes in operation of the processes by which prior art projection systems operate. Advantageously, embodiments of the invention can remove artifact without requiring changes in blocking mask edge profiles.

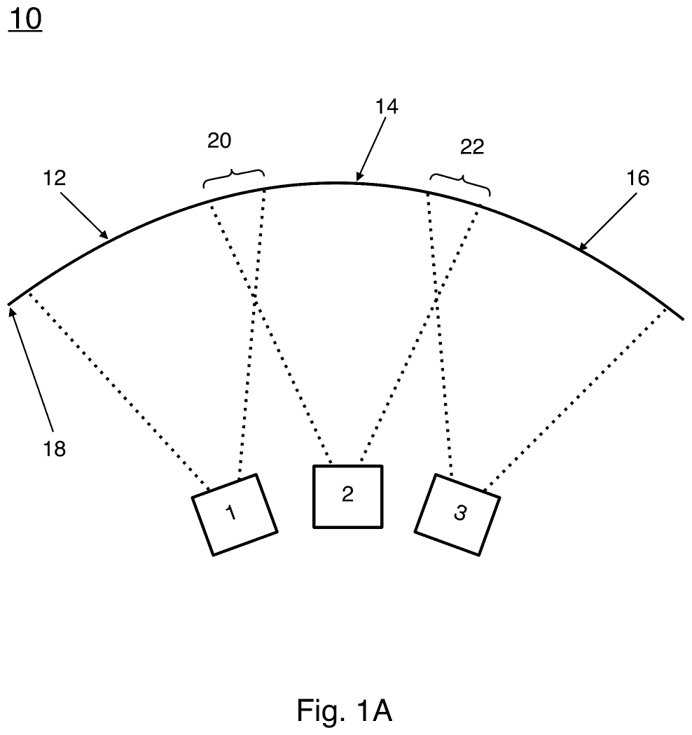

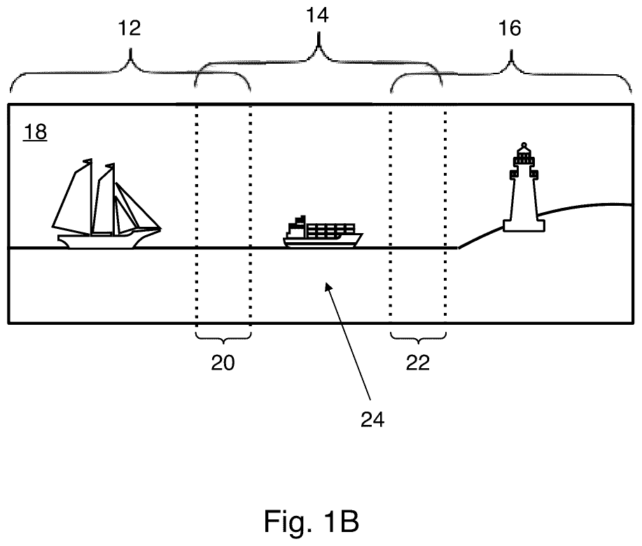

The partial view of FIG. 1A illustrates a multi-projector projection system 10 where three projectors 1, 2, 3 are positioned next to one another as adjoining members in a larger sequence of projectors positioned along one row, or along one in a plurality of horizontal rows and vertical columns of projectors. For purposes of illustration, adjoining projectors in the same row are shown to collectively project partially overlapping tiles 12, 14, 16 on a three-dimensionally curved reflective surface or screen 18 which may display a desired angular view of a scene relative to a horizontal ground plane. Overlap regions 20, 22 exist where the regions along edges of adjoining tiles 12/14, 14/16 exhibit pixel overlap on the screen 18. FIG. 1B is a schematic depiction of an elevation view of a continuous image 24 of a maritime scene created on the screen 18 by the projectors 1, 2, 3. One skilled in the art will appreciate that projection systems may include any number of projectors which may be arranged horizontally and/or vertically to create the desired angular scope of view for a scene.

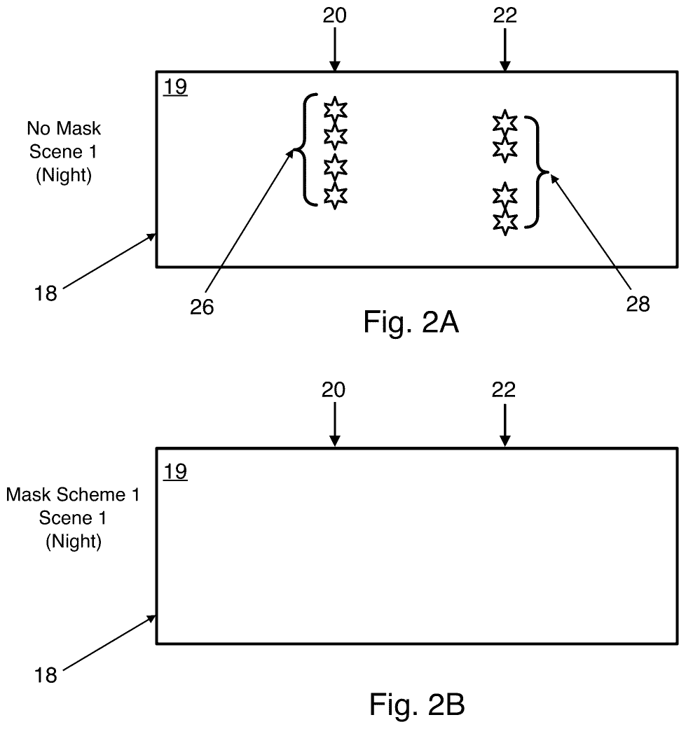

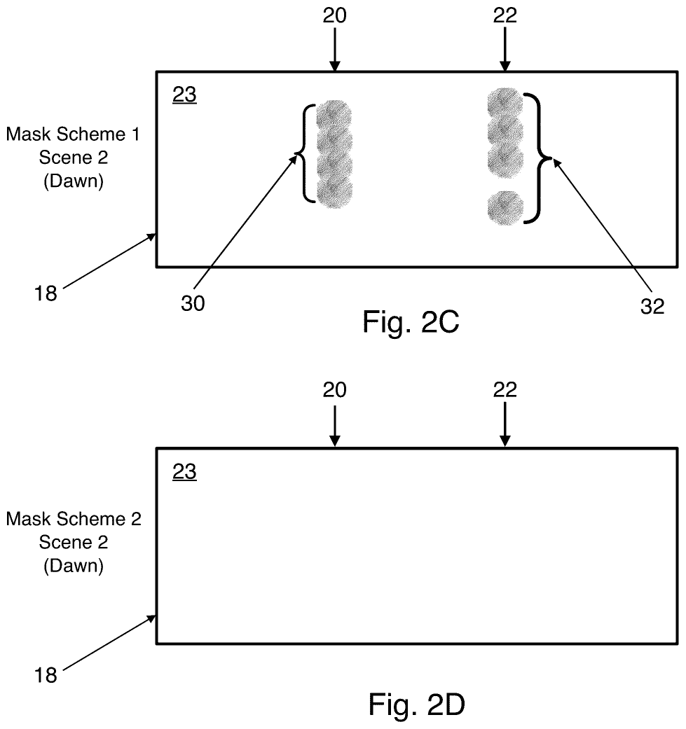

FIGS. 2A-2D are further plan views of the screen 18, with projectors 1, 2, 3 positioned next to one another, schematically illustrating types of brightness artifacts that can occur when projecting scenes under differing conditions, e.g., different levels of brightness which can be attenuated (i.e., reduced or eliminated) with the present invention.

FIG. 2A illustrates a condition under which the projection of a nighttime scene 19 may occur but for which the screen 18 should ideally depict a constant level of very low screen brightness across the entire screen 18. However, when no blocking masks are placed in the beam paths of projectors 1, 2 and 3, there can exist the illustrated condition in which visibly perceptible and undesirable primary artifact is displayed in the form of relatively bright spots or areas 26, 28 in the tile overlap regions 20, 22. The causes of such bright spots may be due to limitations of projection system software intended to operate in conjunction with blocking masks to remove brightness effects due to pixel overlap at higher brightness levels, or may be due to other causes including but not limited to light reflection, diffusion or leakage. The resulting primary artifact 26, 28 may vary in size, brightness or shape among the many tile overlap regions 20, 22 in a screen projection.

For each pair of adjoining projection tiles (e.g., tiles 12, 14) the primary artifact 26, 28 of FIG. 2A can be attenuated by positioning afore-discussed edge profile contours in pairs of blocking masks to define narrow zones of transition between edge portion(s) of adjoining image tiles on the screen 18, i.e., to selectively block light directed to portions of the image tiles 12, 14, 16. The resulting projected scene 19 (not illustrated) more closely achieves a desired constant level of very low brightness across the entire screen 18, as schematically indicated by absence of artifact 26, 28 in FIG. 2B.

A feature of the present invention is based on recognition that, in some situations when a projected scene 19 transitions from a relatively dark brightness level to a relatively brighter level 23, as schematically annotated in FIG. 2C, secondary artifact can become visibly apparent while, at least sometimes, being different in appearance from primary artifacts that may have existed in an unmasked darker scene such as schematically indicated in the scene 19 of FIG. 2A. This may occur, for example, when transitioning from darkness of the nighttime scene 19 and into a relatively brighter level scene 23 (e.g., into or through the initial light of dawn, and trending toward full daylight). Such transitional secondary artifacts are illustrated in FIG. 2C as shadowed areas 30, 32. In these regions comprising secondary artifact the projected image may appear noticeably darker than would be expected based on the intended or expected level of brightness for the scene. As with the primary artifacts of FIG. 2A, such shadowed areas 30, 32 are undesirable when they distract from an expected scene appearance or obscure important information contained in the overlap regions 20, 22. Secondary artifact 30, 32 may be different in shape or brightness from each other or from primary artifact 26, 28, but no explanation is offered with certainty as to the source(s) of, or reasons for, such differences. The differences may be due to variations among any of multiple variables including projector placements, optical or other asymmetries, screen geometry, reflection or diffusion or leakage of light, local screen properties, lighting conditions across the projected image and/or software effects.

To address such differing optical artifact across a range of scene variables, such as artifact related to brightness level, embodiments of the invention adjust one or multiple variables associated with the blocking mask function. One approach is to vary the size of the pixel overlap regions 20, 22, and/or to vary the mask edge profile 38 as a function of screen brightness, thereby implementing a variable masking scheme to reduce secondary artifact as a function of brightness level. Another feature of the present invention is based on recognition that the portion of each projection tile blocked by a mask may vary in response to a parameter that correlates with reducing or eliminating the appearance of an artifact that would otherwise be produced. Such a variable may be an optical parameter of the projected image, such as brightness, location of dominant sources of light within the scene (such as the location of a full moon in a nighttime maritime scene), or another variable in projected scenes that correlates to a reduction in appearance of an optical artifact from scene to scene or from projector to projector. Thus, the same mask(s) utilized in FIG. 2D to mitigate the appearance of secondary artifacts 30, 32 during the brightness transition to or from a relatively brighter scene 23 (e.g., at dawn or dusk) may be positioned to block different respective portions of overlap regions 20, 22 than the portions of overlap regions blocked for FIG. 2B to mitigate primary artifacts 26, 28 in a relatively darker scene 19 (e.g., nighttime). The portions of the overlap regions 20, 22 that are blocked in the relatively brighter scene 23 may typically be smaller than the corresponding portions of the overlap regions 20, 22 that are blocked in the relatively darker scene 19. Features of the invention may include not only blocking more or less total area of the projection beam, e.g., as a function of brightness, but also changing the shape of the portion of the beam that is blocked as the projected image changes.

FIG. 3 schematically illustrates a mask apparatus 34 according to embodiments of the invention that enables implementing multiple different blocking mask schemes with a single mask associated with each projector overlap region, e.g., 20 or 22, and for which the projector can employ as few as one edge profile 38 per overlap region. In other embodiments the mask apparatus 34 can accommodate two or more masks 36 per overlap region or the system 10 may comprise multiple apparatuses, for each projector, in association with the same overlap region, e.g., 20 or 22. Embodiments also include provision of multiple settings for a single mask edge profile 38, in which case optimal blocking mask settings of the edge profile may be automatically adjusted.

Consistent with teachings of the '219 Patent, an embodiment of the mask apparatus 34 shown in FIG. 3 may comprise a single mask 36 formed of opaque material which need only be set to the one edge profile 38 that is optimally adjusted for removal of primary artifact under dark conditions, e.g., digital zero. In this example embodiment, with the adjustable beam-blocking edge profile 38 set for the optimal removal of primary artifact, the same blocking mask can also be used without change to its edge profile to attenuate or completely remove secondary artifact at brightness levels higher than digital zero by simply relocating the mask to block a different portion of the overlap region. That is, advantageously, it has been unexpectedly discovered that when the edge profile 38 is optimized to attenuate or eliminate primary artifact such as 26, 28 of FIG. 2A while the system 10 is projecting a nighttime scene 19, the same edge profile in a different position can be used to attenuate or eliminate secondary artifact, such as relatively dark areas represented in FIG. 2C.

While FIG. 3 illustrates a first embodiment where only a single mask is used to block only one edge of one projection beam, it will be appreciated that currently available multi-projector systems typically utilize one mask for each edge of each of the projection beams that overlap to form one overlap region, e.g., regions 20 or 22. Thus a separate mask positioning apparatus 40 is dedicated for use in each of two overlapping projection beams, and two such mask apparatuses 34 may be used for each overlap region 20 or 22 in a typical embodiment. However, in some embodiments other than the first embodiment, implementations may only require blocking a portion of one of the two partially overlapping projection beams in order to attenuate a particular optical artifact. For the sake of simplification of illustration, only a single mask 36 is shown in FIG. 3 but the apparatus 34 may comprise two or more masks 36.

In the first embodiment, calling for only the single mask 36 of FIG. 3, a variable masking scheme is implemented by simply positioning the mask 36 to different positions, i.e., referred to as a first position 50 and a second position 56, to block different portions of a projection beam in an overlap region 20 or 22, this depending upon the characteristics of the type of optical artifact to be attenuated. To accomplish such movement, the masking apparatus 34 includes a mask positioning mechanism 40 operable to position the mask 36 in any one of a plurality of alternatively selectable positions along a path 41 traversed by the mask 36 relative to the projection beam. Movement may be accomplished by any known mechanism, such as a motor, solenoid, piston, etc., or as illustrated with a stepper motor 42.

In FIG. 3, the first position 50 of the mask 36 is illustrated with solid lines, and a second position 56 of the mask 36 is illustrated with dashed lines. Features shown in the figure are not drawn to scale such that the difference in the two illustrated positions may appear exaggerated for illustration purposes compared to the amount of actual movement that may be needed with the mask positioning mechanism 40. The two illustrated positions may also be reversed, depending on which side of the projector the overlap region is located.

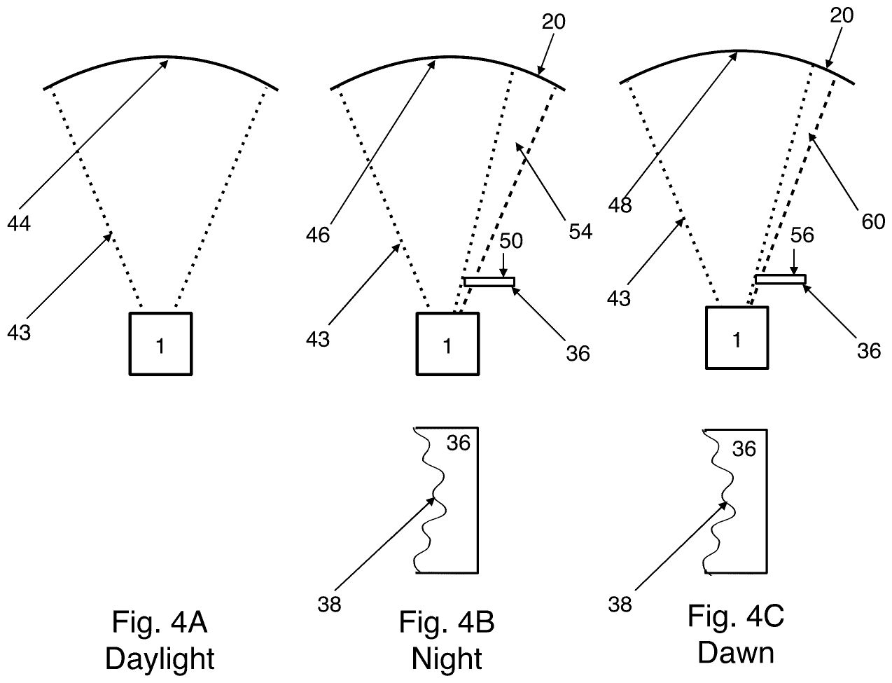

FIGS. 4A-4C further illustrate implementation of embodiments in accord with FIG. 3 where each mask apparatus 34 employs only a single blocking mask 36 with one edge profile setting 38. Two such apparatuses 34 are used for each pair of overlapping projection beams in one of the overlap regions 20 or 22 shown in FIG. 1A. Depending on a characteristic, such as the brightness of a scene being shown on the screen 18, and the type of artifact being mitigated, varied portions of each associated projection beam are blocked in order to mitigate or remove primary or secondary artifact at any given time.

The respective upper portions of FIGS. 4A-4C illustrate a top view of projector 1 shown in FIG. 1A and its associated projection beam 43 for daylight scenes 44 (FIG. 4A), nighttime scenes 46 (FIG. 4B) and transitional scenes 48, i.e., between night and day (FIG. 4C) respectively. In this embodiment, no mask is used for the daylight scene 44 of FIG. 4A, assuming projection system software adequately controls brightness to compensate for the overlap of pixels from adjacent projectors of the system 10. Elevation views of a specific blocking mask 36, such as exemplified in FIG. 3, which is to be inserted along the portion of the beam 43 traversing the overlap region 20, are presented in the respective lower portions of both FIGS. 4B and 4C to illustrate a first fixed edge profile 38 used for both the night time scene 46 and the transitional scene 48. For night time scene 46, the mask 36 is in the first position 50 (indicated with dashed lines), as shown in FIG. 3 to block a first relatively large portion 54 of the projection beam 43 in the overlap region 20 in order to attenuate primary artifact 26, such as undesired bright spots in, as schematically illustrated in FIGS. 2A and 2B. For the transitional scene 48, the same blocking mask 36 also having the same first fixed edge profile 38 is in the second position 56 (indicated with solid lines) as shown in FIG. 3 to block a second, relatively small portion 60 of the projection beam 43 in the overlap region 20 (different from the first portion 54) in order to attenuate, for example, an undesired shadow effect attributable to secondary artifact 30 in overlap region 20, as illustrated in FIGS. 2C and 2D. FIG. 4 do not show the entire overlap region 20.

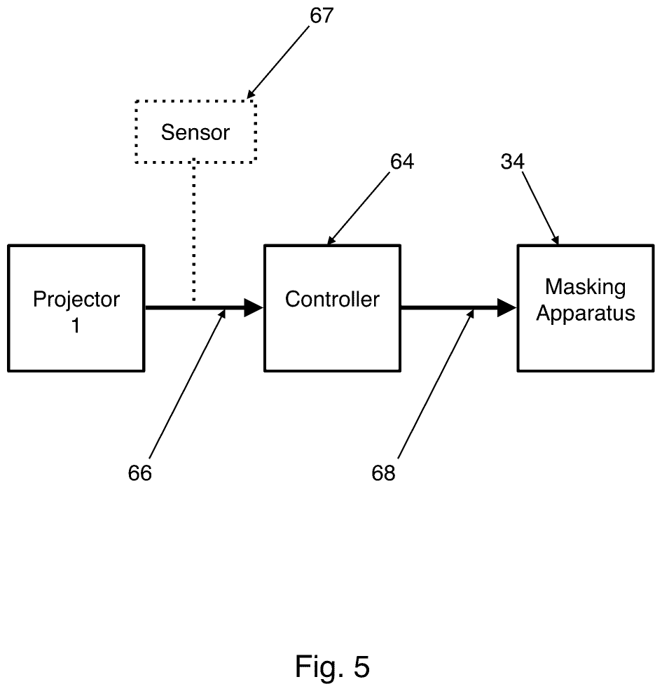

FIG. 5 is a block diagram of an automated control system 62 that may be used in an embodiment of the invention. A controller 64 of any known type (computer, PLC, neural network, human, etc.) receives signal 66 as an input indicative of a variable parameter associated with a scene being projected by projector 1. As discussed above, the signal 66 may be responsive to parameters such as brightness, color, etc. which correlate with a type of undesired artifact that may appear in a projected scene. The means used to determine the parameter may be constructed to be integral with the projector 1 or it may be a separate sensor 67 selected for its ability to detect the parameter of interest. For example, it may be a light sensor for detecting overall or average brightness or brightness level along an interface between adjoining projection tiles, or dominant color or other light-related properties in proximity to the tile overlap regions. Voltage and/or current signals generated within the projector 1 or its associated control system may be used as the means to determine the parameter. A neural network, artificial intelligence or human intelligence may apply subjective criteria in lieu of or together with quantifiable data to determine the parametric values and thresholds.

In response to signal 66, controller 64 provides a mask demand signal 68 to the mask apparatus 34 to implement one or more settings such as a combination of mask positions and edge profiles to block the appropriate portions of projection beams in the projector array so that undesired artifact is attenuated across the screen 18. One skilled in the art will also appreciate that the invention may be implemented without automatic controls based on operator recognition of a parameter relevant to a particular scene condition (e.g., a brightness level) and controlling the position of an appropriate mask. However, automation of such a system and, optionally in combination with artificial intelligence, can ensure accuracy, consistency and rapidity of the masking process, particularly when viewing dynamic variations in a live feed.

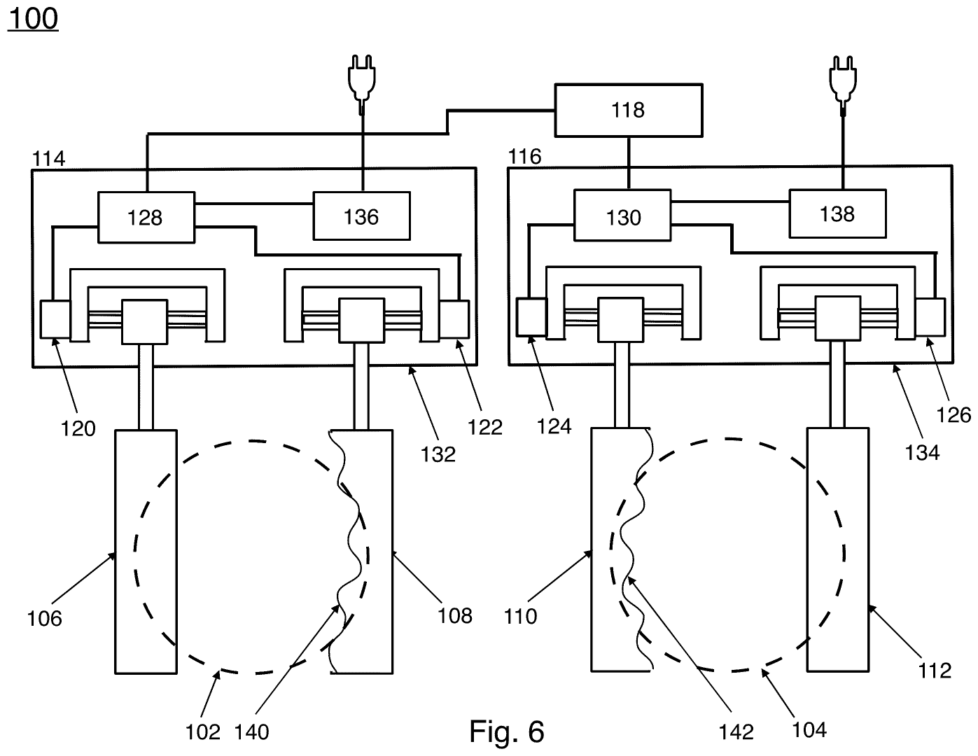

FIG. 6 is a schematic illustration providing a partial elevation view of a portion of an image projection system 100 having a plurality of video projectors (not all shown) arranged to present a continuous image using multiple projection beams, e.g., 102, 104, etc. The illustration provides a view as seen from a position along the projectors and in front of the viewing screen (not shown), looking toward the projector beams 102, 104. Opposed edges of each beam (as shown in FIGS. 1 and 4) are partially blocked by respective mask pairs (106, 108) and (110, 112). The positions of masks 106 and 108 relative to the opposed edges of beam 102 are individually controlled by a mask positioning mechanism 114. A similar mask positioning mechanism 116 is provided to control the positions of masks 110, 112 relative to the opposed edges of projection beam 104. Additional mask positioning mechanisms may be provided for each additional unillustrated projector in the image projection system 100, and the control of the multiple mask positioning mechanisms 114, 116, etc. may be provided by a master controller 118, which may also control the multiple projectors.

The mask positioning mechanisms 114, 116 include respective motors (120, 122) and (124, 126) each associated with corresponding masks 106, 108, 110, 112 as disclosed in the figure, with movement of the motor and mask combinations controlled by local associated controllers 128, 130. These components are mounted on respective frames 132, 134 which also support local power supplies 136, 138.

As discussed above with respect to FIGS. 1A and 1B, it will be appreciated that the projection beams 102, 104 direct a pair of adjoining and overlapping image tiles toward the screen 18, with portions of each image tile in the pair directed toward a common overlap region 20, 22 (not shown) of pre-determinable size on the screen. The overlap region created by beams 102, 104 results from an overlap of the right edge of beam 102 (as viewed in FIG. 6), which is regulated by mask 108, and the left edge of beam 104, which is regulated by mask 110. Thus, to mitigate optical artifacts in that overlap region, at least one, or typically both, of the mask positioning mechanisms 114, 116 are controlled. For example, in one embodiment when projecting a relatively darker nighttime scene, masks 108, 110 are moved to respective first positions to block respective first portions of beams 102, 104 in order to eliminate primary artifact, which may appear as bright spots in the projected scene, resulting from duplicate pixel data and which would otherwise be received in the overlap region from both projection units in the pair, as shown in FIG. 2A. Then, as the scene transitions to a relatively brighter dawn scene, during which undesired shadowy areas may appear (as in FIG. 2C), masks 108, 110 are moved to respective second positions which block respective second portions of beams 102, 104 which are somewhat less in total area than the respective first portions. In this embodiment, the edge profiles 140, 142 of masks 108, 110 are not changed to accomplish this change in the masking scheme but, rather, the masks 108, 110 are simply moved linearly by motors 122, 124 to block lesser portions of the beams 102, 104 for the dawn scene to mitigate secondary artifact.

The master controller 118 may receive or provide a signal responsive to the brightness of the projected scene which, in turn, results in appropriate mask positioning signals provided to motors 122, 124 to accomplish the appropriate masking scheme necessary to mitigate the undesired optical artifact. The specific mask positions that provide optimal results under various scene lighting conditions may be determined experimentally, e.g., along with an edge profile, when a projection system is first calibrated to take into account application-specific variables such as projector positioning, screen curvature, software blending characteristics, mask effectiveness, etc. These mask positions may then be pre-programmed into the system 100 and then automatically implemented upon receipt of a corresponding scene parameter signal. Advantageously, the above features can be applied to live feeds.

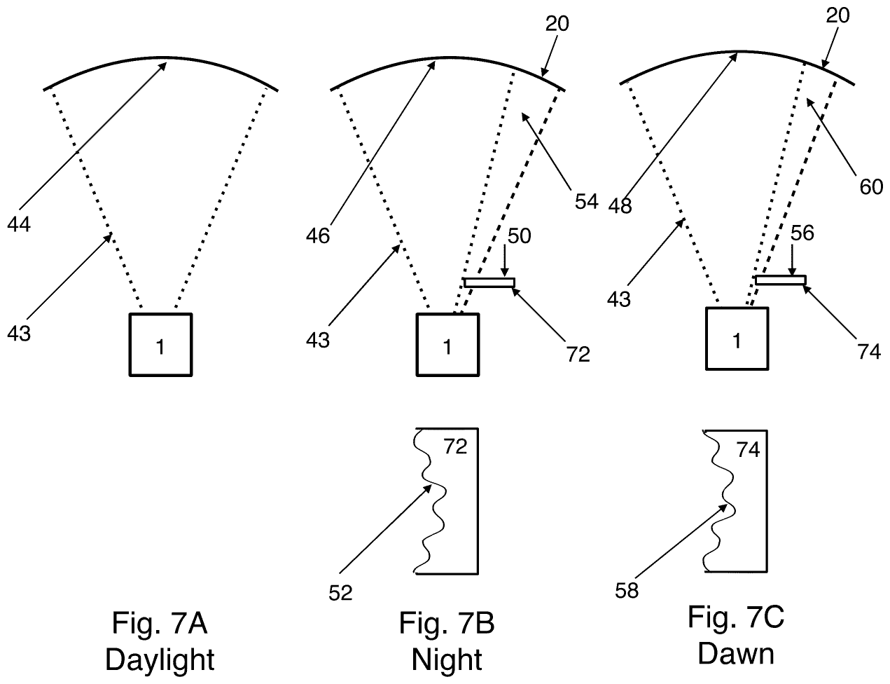

FIGS. 7A-7C illustrate another embodiment of the invention wherein a variable masking scheme is implemented by utilizing a plurality of masks to block differing portions of a projection beam depending upon a characteristic (e.g., screen brightness) of the scene being projected. The respective upper portions of FIGS. 7A-7C illustrate plan views of projector 1 of projection system 10 and its associated projection beam 43 for daylight 44 (FIG. 7A), nighttime 46 (FIG. 7B) and transitional scenes 48, i.e., between night and day (FIG. 7C) respectively. The respective lower portions of FIGS. 7B and 7C illustrate an elevation view of a pair of masks 7260, 7466 used for the respective scenes and applying differing edge profiles with the masks 72, 7460, 66. In this embodiment, no mask is used for the daylight scene 44, assuming projection system software adequately controls brightness to compensate for the overlap of pixels from adjacent projectors of the system 10. For nighttime scene 46, the first mask 7260 having a first edge profile 52 is used to block a first portion 54 of the projection beam 43 in order to attenuate undesired primary artifact 26, such as undesired bright spots in overlap region 20, as illustrated in FIGS. 2A and 2B. For a transitional dawn scene 48, a second mask 74 having a second edge profile 58, different than edge profile 52, is used to block a second and smaller portion 60 of the projection beam 43 (different from the first portion 54) in order to attenuate, for example, undesired shadowy artifact 30 in overlap region 20, as illustrated in FIGS. 2C and 2D. FIG. 7 do not show the entire overlap region 20.

While various embodiments of the present invention have been shown and described herein, it will be apparent that such embodiments are provided by way of example only. For example, while only horizontally arranged projectors are illustrated herein, it will be appreciated that the variable masking schemes described herein may be advantageously applied to overlap regions created by vertically stacked projectors. Numerous variations, changes and substitutions may be made without departing from the invention herein. Accordingly, it is intended that the invention be limited only by the spirit and scope of the appended claims.

The invention claimed is:

1. A method of projecting a scene using a plurality of projectors each projecting a beam to form a respective tile of the scene on a reflective surface, with adjacent tiles partially overlapping in respective overlap regions, and together forming a continuous projected scene across the reflective surface, the method comprising:
masking a first portion of a first beam to attenuate a first optical artifact appearing in a first overlap region of the reflective surface while projecting a first scene; and
masking a second portion of the first beam, different from the first portion, to attenuate a second optical artifact appearing in the first overlap region of the reflective surface while projecting a second scene different from the first scene.

2. The method of claim 1, wherein an ambient level of scene brightness of the first scene is relatively darker than an ambient level of scene brightness of the second scene.

3. The method of claim 1, wherein the first scene is a nighttime scene and the second scene is a dawn or dusk scene.

4. The method of claim 1, further comprising:
masking the first portion of the first beam by positioning a mask in a first position relative to the first beam; and
masking the second portion of the first beam by positioning the mask in a second position relative to the first beam.

5. The method of claim 4, further comprising using a stepper motor to move the mask between the first and second positions.

6. The method of claim 1, further comprising:
masking the first portion of the first beam by positioning a mask having a first shape in the first beam; and
masking the second portion of the first beam by positioning a mask having a second shape different than the first shape in the first beam.

7. The method of claim 1, wherein appearance of a respective optical artifact in a respective scene is correlated to an optical parameter that varies between scenes, the method further comprising selecting a portion of the first beam to mask in response to a value of the optical parameter for a respective scene being projected.

8. The method of claim 7, wherein the optical parameter comprises brightness.

9. The method of claim 7, wherein the optical parameter comprises color.

10. The method of claim 7, further comprising:
providing a signal responsive to the optical parameter for a particular scene; and
automatically selecting which portion of the first beam to mask when the scene is projected onto the reflective surface in response to the signal.

11. An image projection system operable to practice the method of claim 1, the image projection system further comprising a subsystem configured to move a mask to a first position to mask the first portion of the first beam and to move the mask to a second position to mask the second portion of the first beam.

12. The image projection system of claim 11, wherein the subsystem comprises a stepper motor.

13. An image projection system operable to practice the method of claim 1, the image projection system further comprising a first mask for masking the first portion of the first beam and a second mask for masking the second portion of the first beam.

14. An image projection system comprising:
at least a pair of projectors operable to project a respective pair of partially overlapping image tiles onto a surface to create a continuous image of a scene across the surface;
a masking apparatus comprising at least one mask positionable to partially block a portion of at least one of the image tiles in order to attenuate an optical artifact in the continuous image in a region where the image tiles overlap; and
a controller operable to command the masking apparatus to block a first portion of the at least one of the image tiles when the system projects a first scene, and to command the masking apparatus to block a second portion of the at least one of the image tiles, different from the first portion, when the system projects a second scene, the first and second scenes differing in an optical parameter that results in different respective first and second artifacts in the region where the image tiles overlap.

15. The image projection system of claim 14, wherein the masking apparatus comprises a motor operable to move the mask between the first and second positions, the motor responsive to a command from the controller.

16. The image projection system of claim 15, wherein the motor comprises a stepper motor.

17. The image projection system of claim 14, wherein the controller receives a signal responsive to the differing parameter of a projected scene and operates to position the mask to either the first or second position in response to a value of the signal.

18. The image projection system of claim 17, wherein the differing parameter comprises brightness or color.

19. In a multi-projector continuous scene projecting system wherein an overlap of adjacent projection tiles gives rise to undesired optical artifacts in a projected continuous scene image, an improvement comprising:
a masking apparatus operable to block a portion of a projection beam forming at least one of the tiles;
a means for determining an optical parameter of a projected image; and
a means for controlling the masking apparatus to block a first portion of the at least one of the tiles to attenuate a first artifact in response to a projected image having an optical parameter of a first value, or alternatively to block a second portion of the at least one of the tiles to attenuate a second artifact in response to a projected image having an optical parameter of a second value.

20. The improvement of claim 19, wherein the optical parameter comprises a brightness parameter.
